(19) United States
(12) Patent Application Publication
(10) Pub. No.: US 2022/0036357 A1
(43) Pub. Date: Feb. 3, 2022

(54) SYSTEMS AND METHODS FOR PROCESSING FINANCIAL TRANSACTIONS USING SUSPENDED ACCOUNTS

(71) Applicant: Fidelity Information Services, LLC, Jacksonville, FL (US)

(72) Inventors: Shannon BUNZEY, St. Petersburg, FL (US); Christian BARTH, Saint Petersburg, FL (US); Jude SIMONIS, Saint Petersburg, FL (US); Anand LIKHITE, Casselberry, FL (US); Jacob Randall PRICE, Trussville, AL (US); Shelley LEFLER, St Petersburg, FL (US)

(73) Assignee: Fidelity Information Services, LLC, Jacksonville, FL (US)

(21) Appl. No.: 16/983,711

(22) Filed: Aug. 3, 2020

(51) Int. Cl. G06Q 20/40; G06Q 20/32

(52) U.S. Cl. CPC G06Q 20/405; G06Q 20/322; G06Q 20/407; G06Q 20/4016

(57) ABSTRACT

Computer-implemented systems and methods for processing a financial transaction include determining a temporary identifier associated with an account number based on a determination that the account number is suspended, determining a security code associated with the account number when a payment comprising the account number occurs, indicating the temporary identifier and the security code to an apparatus associated with the account number, and continuing processing the payment if received transaction data of the payment comprises at least one of the temporary identifier or the security code.

### TECHNICAL FIELD

The present disclosure generally relates to computerized methods and systems for processing financial transactions using a payment network and, more particularly, to computerized methods and systems for processing financial transactions using suspended accounts.

### BACKGROUND

Traditional payment networks are configured to process and enable financial transactions between various financial entities and merchants through the transfer of cash having a particular cash value. The transfer of cash or traditional cash-substitutes may be accomplished using negotiable instruments and/or electronic payment means including debit cards, credit cards, electronic fund transfers, etc. Each transfer thereof may be subject to procedures and protocols of a payment network based on one or more transaction rules associated with the payment network.

Data breaches are a rising threat to financial accounts. When a data breach occurs, an account number (e.g., a credit or debit card number) of a user (e.g., an individual or a corporation) may be compromised and exposed to third parties, subject to potential unauthorized financial transactions. Traditional payment networks and financial service providers may protect the account number by detecting the data breach, identifying and freezing the compromised account number, declining all transactions under the compromised account number, and issuing a new account number to the user.

One problem with typical systems is that they cannot send the new account number to the user immediately. For example, the new account number may arrive in a physical form (e.g., a physical card) through the mail or courier services. Before receiving the new account number, the user can no longer use the compromised account number for financial transactions, such as point-of-sale transactions, online transactions, or recurring transactions. As a result, the user may experience an inconvenient and frustrating experience, especially when the user is unaware of the account number being frozen until a transaction is declined. Although some solutions may provide the new account number to the user using a digital wallet, the user is still limited to use the compromised account number in situations where physical cards are required. Further, the financial service provider that issues the new account number may risk losing a current customer because the user may choose to use another card in her wallet or even cancel the compromised account number and apply for a new account from another financial service provider to satisfy her speedy needs of financial transactions.

Therefore, a need exists in the financial service industry to temporarily enable a transaction to be processed under compromised accounts. The present disclosure is directed to addressing these and other challenges.

### SUMMARY

One aspect of the present disclosure is directed to a computer-implemented system. The system comprises a non-transitory computer-readable medium configured to store instructions and at least one processor configured to execute the instructions to perform operations. The operations include determining a temporary identifier associated with an account number based on a determination that the account number is suspended, determining a security code associated with the account number when a payment comprising the account number occurs, indicating the temporary identifier and the security code to an apparatus associated with the account number, and continuing processing the payment if received transaction data of the payment comprises at least one of the temporary identifier or the security code.

Other aspects of the present disclosure are directed to computer-implemented methods for performing the functions of the computer-implemented systems discussed above.

Other systems, methods, and computer-readable media are also discussed herein.

### BRIEF DESCRIPTION OF THE DRAWINGS

FIG. 1 is a schematic diagram of an example system for processing a financial transaction, consistent with the disclosed embodiments.

FIG. 2 is a block diagram of an example server computer system for processing a financial transaction, consistent with the disclosed embodiments.

FIG. 3 is a block diagram of an example user device 110 shown in FIG. 1, consistent with the disclosed embodiments.

FIGS. 4A-4B depict example interfaces presented on user device 110, consistent with the disclosed embodiments.

FIG. 5 depicts another example interface shown on user device 110, consistent with the disclosed embodiments.

FIG. 6 depicts yet another example interface shown on user device 110, consistent with the disclosed embodiments.

FIG. 7 is a flowchart of an example process for processing a financial transaction in the system shown in FIG. 1, consistent with the disclosed embodiments.

FIG. 8 is a flowchart of example process 800 for processing a financial transaction in system 100, consistent with the disclosed embodiments.

### DETAILED DESCRIPTION

The disclosed embodiments include systems and methods for processing financial transactions. Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present example embodiments of the disclosure, examples of which are illustrated in the accompanying drawings. Wherever possible, the same reference numbers will be used throughout the drawings to refer to the same or like parts.

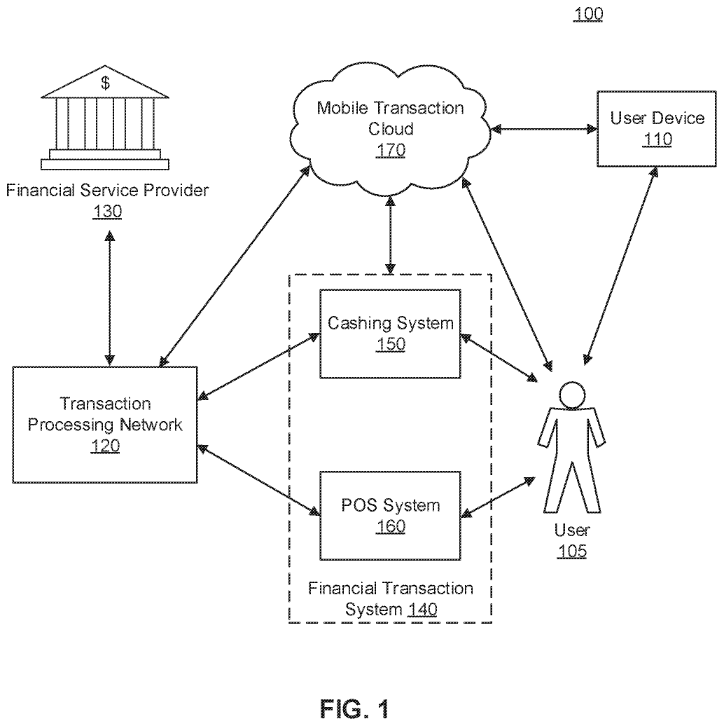

FIG. 1 is a schematic diagram illustrating an example system 100 for processing a financial transaction, consistent with the disclosed embodiments. For example, the financial transaction processed by system 100 may be in the form of check payments, debit card payments, credit card payments, electronic payment made through the Automated Clearing House (ACH) Network, Real-Time Payment Network, wire transfers, electronic payments, peer-to-peer payments, mobile payments (e.g., Apple Pay®), electronic fund payment (e.g., Zelle®), or the like. Moreover, the payments processed by system 100 may include recurring payments, such as payments of utility bills, providing paychecks to an employee through direct deposits, mortgage payments, or the like. As shown in FIG. 1, system 100 includes transaction processing network 120, financial service provider 130, financial transaction system 140, and mobile transaction cloud 170.

In FIG. 1, transaction processing network 120 may include one or more computer systems associated with one or more financial entities, such as a financial service provider 130. Transaction processing network 120 may be an Interbank Network (such as NYCE®, INTERAC®, or the like). Interbank Networks allow money systems (such as ATMs or payment terminals) to access deposit or other accounts. In some embodiments, transaction processing network 120 may enable the use of ATM cards issued by a bank to be used at a point of sale through an EFTPOS (Electronic Fund Transfer at Point Of Sale) system. Rather than operating as a credit card transaction, which would typically need to go through a credit card issuer system, an EFTPOS transaction could be received by transaction processing network 120 and routed to the appropriate bank holding the account.

In some embodiments, transaction processing network 120 may provide transaction processing service between user 105 and one or more financial service providers 130 through financial transaction system 140, such as a cashing system 150 (e.g., ATM) or a point-of-sale (POS) system 160. Consistent with the present disclosure, transaction processing network 120 receives one or more requests for processing transactions initiated by user 105 (e.g., by a card swipe, a mobile payment, an online payment, or the like) or financial transaction system 140. In the disclosed embodiments, transaction processing network 120 may be developed and operated by a third-party service provider authorized by financial service provider 130 to process financial transactions. In other embodiments, Transaction processing network 120 may be associated with one or more financial service provider 130 for processing financial transactions.

Transaction processing network 120 may include one or more components that perform processes consistent with the disclosed embodiments. For example, transaction processing network 120 may include one or more computers (e.g., server computers, database systems, etc.) that execute software instructions programmed to perform aspects of the disclosed embodiments, such as collecting data regarding transaction requests, processing transaction requests according to one or more transaction rules, processing authentication requests, authorizing transactions, transmitting authorization responses, or settling completed financial transactions.

In some embodiments, transaction processing network 120 may provide a connectivity infrastructure for enabling communication among the various entities and financial transaction system 140 and for processing transactions and/or payment transfers. In some embodiments, transaction processing network 120 may be implemented as part of or in conjunction with a Local Area Network (LAN) or a Wide Area Network (WAN) (such as the internet), and may be a single network or a combination of networks. In some embodiments, transaction processing network 120 may be implemented as a single type of network or a combination of different types of networks (e.g., networks for wireline and/or wireless communications). In some embodiments, transaction processing network 120 may also utilize cloud computing technologies (e.g., for storage, caching, or the like). In some embodiments, transaction processing network 120 can be national, international, or both.

In some embodiments, transaction processing network 120 may include a switch, which may act as a back-end processing system for transaction terminals (e.g., ATMs, POS machines, or the like). The switch may route transaction data between transaction terminals and other components of transaction processing network 120 through one or more communication routes (e.g., LAN, WAN, or any type of network) in transaction processing network 120. For example, when a PIN number associated with an account number is entered at a transaction terminal (e.g., a POS machine) during a transaction, the transaction terminal may send the account number and the entered PIN to the switch, which may further route them to a hardware security module (HSM) for validation. In another example, when a PIN number associated with an account number is updated at a back-end server (e.g., user changes PIN at a bank branch), the back-end server may send the account number and the updated PIN to the switch, which may further route them to the HSM to enable it to process future transactions comprising the account number and the updated PIN. It should be noted that transaction processing network 120 is not limited to the above examples, and system 100 may implement any type of network that allows the entities (shown and not shown) included in FIG. 1 to exchange data and information.

Financial service provider 130 may be an entity that provides financial services. For example, financial service provider 130 may be a bank, a check clearinghouse, or another type of financial service entity that configures, offers, provides, and/or manages financial service accounts, such as checking accounts, savings accounts, debit card accounts, credit card accounts, loyalty accounts, etc. These financial service accounts may be used by user 105 to purchase goods and/or services. Financial service provider 130 may include one or more components that perform processes consistent with the disclosed embodiments. The computer systems of financial service provider 130 may be communicatively connected to computer systems in transaction processing network 120. In some embodiments, one or more components in both financial service provider 130 and transaction processing network 120 may cooperate to perform processes consistent with the disclosed embodiments.

Financial transaction system 140 may include one or more of cashing system 150 or POS system 160. Cashing system 150 may be implemented as a computer or other electronic device operable to receive a cash withdrawal transaction request from a user device 110. In some embodiments, cashing system 150 may be implemented as an automated teller machine (ATM) configured to receive data associated with user 105. In other embodiments, cashing system 150 may be implemented at one or more retail locations. Transaction processing network 120 associated with cashing system 150 may receive an account number from user 105 (e.g., by a card swipe) and transmit a cash withdrawal transaction request to transaction processing network 120. The processor associated with cashing system 150 may also receive a cash withdrawal transaction request from user device 110 (e.g., an authenticated smartphone) associated with user 105 through an application program interface (API). Cashing system 150 may be configured to receive instructions from transaction processing network 120 for dispensing cash to user 105.

POS system 160 may be a computer system or other electronic device operable to transmit a POS transaction request for completing a financial transaction using a cash substitute. For example, POS system 160 may include a POS machine. The POS machine may receive an account number (e.g., by a card swipe, a chip-card insertion, a contactless-card tap, or the like) from user 105. In another example, POS system 160 may include a mobile payment machine that may receive the account number (e.g., by receiving an NFC tap, scanning a QR code, or the like) from user device 110 that provides a digital wallet (e.g., Apple Pay®, Google Pay®, Samsung Pay®, or the like). After receiving the account number, POS system 160 may transmit a POS transaction request that includes the account number to transaction processing network 120 or financial service provider 130 for identifying a financial account associated with user 105. In some embodiments, transaction processing network 120 or financial service provider 130 may send an additional request to POS system 160 to receive an identifier (e.g., a PIN number) for some types of transactions (e.g., a debit card transaction). POS system 160 may receive the identifier from user 105 (e.g., by receiving a keypad input) or user device 110 (e.g., by receiving a touchscreen input) and send the identifier to transaction processing network 120 to proceed the transaction. After the transaction being authorized by transaction processing network 120 or financial service provider 130, POS system 160 may receive an indication (e.g., a receipt, a text message, a push notification, an information page, or the like) from transaction processing network 120 that payment is authorized.

In some embodiments, POS system 160 may also be operable to split the monetary amount of the POS transaction request into more than one portion and create a corresponding number of POS transaction requests for completing the financial transaction using any combination of cash or one or more cash substitutes, which may allow a customer to utilize more than one mode of payment to pay for goods or services. In this case, POS system 160 may split the monetary amount and generate a corresponding number of POS transaction requests with the portions of the monetary amount. POS system 160 may then process each of the POS transaction requests.

In some embodiments, POS system 160 may be implemented as an attended machine (e.g., by a cashier or clerk) or an automated kiosk (e.g., by user 105 actuating a screen or buttons on an unmanned or cashier-less kiosks) operable to transmit a request for processing payment of the transaction to transaction processing network 120. In some embodiments, POS system 160 may be implemented as a personal computer, online terminal, or mobile device operating a software application configured to generate a transaction request and transmit the POS transaction request to transaction processing network 120. In some embodiments, POS system 160 may be a retail point-of-sale device, e-commerce website, or mobile application configured to receive account information.

In some embodiments, user 105 may initiate an electronic payment using user device 110. For example, user device 110 may be installed with applications such as Apple Pay® or Zelle®, which can be used to initiate a payment or fund transfer. User device 110 may be a mobile phone, a personal computer, a wearable device (e.g., a smartwatch, smart glasses, etc.), a messaging device, a gaming console, a tablet computer, a personal digital assistant, or the like.

Mobile transaction cloud 170 may provide a connectivity infrastructure for enabling communication among financial service provider 130 via transaction processing network 120, financial transaction system 140, and user device 110. Mobile transaction cloud 170 may be implemented using a wireless network, a cellular network, a satellite network, or the like. Mobile transaction cloud 170 may serve, for example, as a second communication channel, separate from the communication between transaction processing network 120 and financial transaction system 140, for verifying information during an initial registration process or during each transaction request to prevent fraudulent activity, in a manner consistent with the disclosed embodiments. In some embodiments, mobile transaction cloud 170 may work in conjunction with user device 110 to verify information using known techniques such as multi-factor authentication, biometric authentication (e.g., a fingerprint scan, an iris scan, face recognition, etc.), or the like.

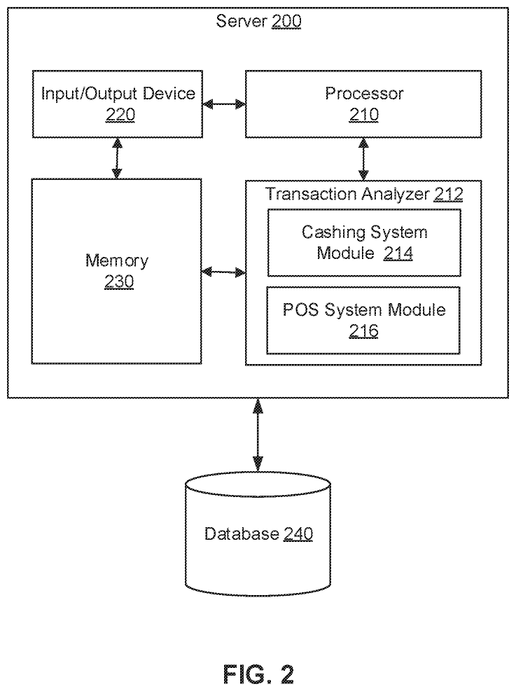

FIG. 2 is a block diagram of an example server computer system 200 (referred to as “server 200” hereinafter) used in system 100, consistent with the disclosed embodiments. For example, server 200 may be used in transaction processing network 120 or financial service provider 130. Server 200 may be one or more computing devices configured to execute software instructions stored in memory to perform one or more processes consistent with the disclosed embodiments. For example, server 200 may include one or more memory devices for storing data and software instructions and one or more hardware processors to analyze the data and execute the software instructions to perform server-based functions and operations (e.g., back-end processes).

In FIG. 2, server 200 includes a hardware processor 210, an input/output (I/O) device 220, and a memory 230. It should be noted that server 200 may include any number of those components and may further include any number of any other components. Server 200 may be standalone, or it may be part of a subsystem, which may be part of a larger system. For example, server 200 may represent distributed servers that are remotely located and communicate over a network.

Processor 210 may include or one or more known processing devices, such as, for example, a microprocessor. In some embodiments, processor 210 may include any type of single or multi-core processor, mobile device microcontroller, central processing unit, etc. In operation, processor 210 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in memory 230, processor 210, or elsewhere.

I/O device 220 may be one or more devices configured to allow data to be received and/or transmitted by server 200. I/O device 220 may include one or more customer I/O devices and/or components, such as those associated with a keyboard, mouse, touchscreen, display, etc. I/O device 220 may also include one or more digital and/or analog communication devices that allow server 200 to communicate with other machines and devices, such as other components of system 100. I/O device 220 may also include interface hardware configured to receive input information and/or display or otherwise provide output information. For example, I/O device 220 may include a monitor configured to display a customer interface.

Memory 230 may include one or more storage devices configured to store instructions used by processor 210 to perform functions related to disclosed embodiments. For example, memory 230 may be configured with one or more software instructions associated with programs and/or data.

Memory 230 may include a single program that performs the functions of the server 200, or multiple programs. Additionally, processor 210 may execute one or more programs located remotely from server 200. Memory 230 may also store data that may reflect any type of information in any format that the system may use to perform operations consistent with disclosed embodiments. Memory 230 may be a volatile or non-volatile (e.g., ROM, RAM, PROM, EPROM, EEPROM, flash memory, etc.), magnetic, semiconductor, tape, optical, removable, non-removable, or another type of storage device or tangible (i.e., non-transitory) computer-readable medium.

Consistent with the disclosed embodiments, server 200 includes transaction analyzer 212 configured to receive a transaction request and orchestrate one of cashing system module 214 or POS system module 216 for processing the transaction request. Transaction analyzer 212 may be implemented as software (e.g., program codes stored in memory 230), hardware (e.g., a specialized chip incorporated in or in communication with processor 210), or a combination of both. Transaction analyzer 212 may include a cashing system module 214 and a POS system module 216. Cashing system module 214 may be configured to communicate with cashing system 150 to input or output transaction data related to cash (e.g., depositing or withdrawing case, cashback at point of sale, or the like). POS system module 216 may be configured to communicate with POS system 160 to input or output transaction data unrelated to cash (e.g., payments, fund transfers, or the like). In some embodiments, cashing system module 214 and/or a POS system module 216 may be organized or arranged separately from transaction analyzer 212. In further embodiments, cashing system module 214 and POS system module 216 may be combined into one module serving the functions of both modules.

Server 200 may also be communicatively connected to one or more databases 240. For example, server 200 may be communicatively connected to database 240. Database 240 may be a database implemented in a computer system (e.g., a database server computer) in transaction processing network 120 or financial service provider 130. Database 240 may include one or more memory devices that store information and are accessed and/or managed through server 200. By way of example, database 240 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, server 200 may include database 240. Alternatively, database 240 may be located remotely from the server 200. Database 240 may include computing components (e.g., database management system, database server, etc.) configured to receive and process requests for data stored in memory devices of database 240 and to provide data from database 240.

In an example, transaction analyzer 212 may include instructions to call an API for processing transactions for a compromised account associated with user 105. In some embodiments, the API may communicate with financial service provider 130 to verify whether any transaction through the compromised account may be conducted against a database of account holders at financial service provider 130. If such a transaction is permitted to be conducted, the services related to the API may generate authorization information related to the transaction through the compromised account. In some embodiments, the authorization information may be transmitted (e.g., via a mobile device application, a text message, a phone call, or the like) to user device 110 to be presented (e.g., displayed as text or graph, or played as sound) to user 105. The authorization information may include one or more of, for example, a first name, last name, account name, phone number, email address, passphrase, or a temporary identifier. User 105 may use the authorization information to complete the transaction despite the account being compromised.

For example, user 105 may enter the authorization information into POS system 160 (or cashing system 150), which may further transmit the authorization information to POS system module 216 (or cashing system module 214) of server 200. Once receiving the authorization information, the API may verify whether the authorization information received by POS system module 216 (or cashing system module 214) matches the authorization information generated by the services related to the API. If so, transaction analyzer 212 may approve the transaction through the compromised account, and the API may communicate with financial service provider 130 again to complete the transaction. On the other hand, if the API determines that the authorization information received by POS system module 216 (or cashing system module 214) does not match with the authorization information generated by the services related to the API, transaction analyzer 212 may reject the transaction to protect the compromised account.

For example, transaction analyzer 212 may generate a temporary identifier to be included in the authorization information. The temporary identifier may be a series of random characters in any form, for example, alphanumeric, alphabetic, numeric, text, hash-based, or binary. The temporary identifier may be generated by, for example, a pseudo-random generator. The temporary identifier may only be used for the current transaction and may expire after a preset interval (e.g., 2 minutes) of time. By using the temporary identifier, the transaction may be conducted despite the fact that the account is compromised while maintaining the security of the account for user 105.

In some embodiments, transaction analyzer 212 may transmit one or more transaction rules to cashing system 150 or POS system 160 in FIG. 1 for different transaction types. For example, POS system 160 may receive two transaction rules, one from cashing system module 214 for determining a cash payment amount or a cash withdrawal amount (e.g., in a transaction requesting for cashback), and the other from POS system module 216 for a card payment amount.

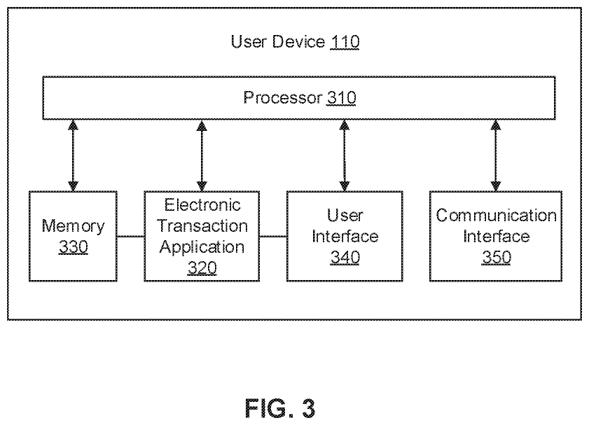

FIG. 3 is a block diagram of an example user device 110 used in system 100, consistent with the disclosed embodiments. As shown in FIG. 3, user device 110 may include a hardware processor 310, an electronic transaction application 320, a memory 330, a user interface 340, and a communication interface 350. In some embodiments, processor 310 may be similar to processor 210, and memory 330 may be similar to memory 230.

Processor 310 may include a digital signal processor, a microprocessor, or another appropriate processor to facilitate the execution of computer instructions encoded in a computer-readable medium. Processor 310 may be configured as a separate processor module dedicated to making an electronic payment. Alternatively, processor 310 may be configured as a shared processor module for performing other functions of user device 110 unrelated to the disclosed methods for making an electronic payment. In some embodiments, processor 310 may execute computer instructions (e.g., program codes) stored in memory 330, and may perform functions in accordance with example techniques described in this disclosure.

Memory 330 may include any appropriate type of mass storage provided to store information that processor 310 may need to operate. Memory 330 may be a volatile or non-volatile, magnetic, semiconductor, tape, optical, removable, non-removable, or another type of storage device or tangible (i.e., non-transitory) computer-readable medium including, but not limited to, a ROM, a flash memory, a dynamic RAM, and a static RAM. Memory 330 may be configured to store one or more computer programs that may be executed by processor 310 to perform the disclosed functions for making an electronic payment.

Electronic transaction application 320 may be a module dedicated to performing functions related to initiating an electronic transaction (e.g., a payment or fund transfer). Electronic transaction application 320 may be configured as hardware, software, or a combination thereof. For example, electronic transaction application 320 may be implemented as computer code stored in memory 330 and executable by processor 310. As another example, electronic transaction application 320 may be implemented as a special-purpose processor, such as an application-specific integrated circuit (ASIC), dedicated to make an electronic payment. As yet another example, electronic transaction application 320 may be implemented as an embedded system or firmware, and/or as part of a specialized computing device.

User interface 340 may include a graphical interface (e.g., a display panel), an audio interface (e.g., a speaker), or a haptic interface (e.g., a vibration motor). For example, the display panel may include a liquid crystal display (LCD), a light-emitting diode (LED), a plasma display, a projection, or any other type of display. The audio interface may include microphones, speakers, and/or audio input/outputs (e.g., headphone jacks).

User interface 340 may also be configured to receive input or commands from user 105. For example, the display panel may be implemented as a touch screen to receive input signals from the user. The touch screen includes one or more touch sensors to sense touches, swipes, and other gestures on the touch screen. The touch sensors may sense not only a boundary of a touch or swipe action but also a period of time and a pressure associated with the touch or swipe action. Alternatively, or additionally, user interface 340 may include other input devices such as keyboards, buttons, joysticks, and/or trackballs. User interface 340 may be configured to send the user input to processor 310 and/or electronic transaction application 320.

Communication interface 350 can access a network (e.g., mobile transaction cloud 170) based on one or more communication standards, such as WiFi, LTE, 2G, 3G, 4G, 5G, etc. In some embodiments, communication interface 350 may include a near field communication (NFC) module to facilitate short-range communications between user device 110 and other devices. In other embodiments, communication interface 350 may be implemented based on radio-frequency identification (RFID) technology, an infrared data association (IrDA) technology, an ultra-wideband (UWB) technology, a Bluetooth® technology, or other technologies.

User device 110 is not always needed when user 105 conducts financial transactions (e.g., a card-based transaction). In some embodiments, user 105 may use user device 110 to initiate an electronic payment without using a physical card. For example, in one embodiment, processor 310 or electronic transaction application 320 may display, on user interface 340, payment information (e.g., a name, an account number, a date, a verification code, etc.) for user 105 to confirm (e.g., by entering authentication information, biometric authentication, or the like). When payment information is confirmed, processor 310 may send transaction data via communication interface 350 to server 200 (e.g., through financial transaction system 140 or mobile transaction cloud 170) for processing. After receiving the transaction data (e.g., through cashing system module 214 or POS system module 216), server 200 may authenticate (e.g., by transaction analyzer 212) the payment information included in the transaction data and authorize the payment.

With server 200 as shown and described in FIG. 2 and user device as shown and described in FIG. 3, this disclosure provides systems and methods for processing financial transactions using compromised financial accounts due to data breaches. A data breach may occur to a financial account belonging to user 105. For example, an account number (e.g., a credit or debit card number) of the financial account may be compromised and exposed to a malicious third party. The funds in the compromised account may face a risk of being depleted by the malicious third party. Consistent with the embodiments of this disclosure, to protect the security of the financial account, financial service provider 130 may lock (“freeze”) the financial account once detecting that the financial account is compromised. Any transaction through the compromised account number may be declined or halted for further verification. Financial service provider 130 may issue a replacement account number (e.g., by issuing a new physical card) to user 105, which may be used after user 105 receives it and activate it. However, in a transition period between when the compromised account number is frozen and when user 105 receives the replacement account number, user 105 may not be able to use the financial account for many types of transactions, such as, for example, recurring transactions (e.g., for utility bills), in-person transactions (e.g., a card-swipe transaction or a mobile payment), or online transactions.

To mitigate the inconvenience for user 105 of being unable to use the compromised account number in some scenarios (e.g., in an in-person transaction or online transaction), financial service provider 130 may notify user 105 of the data breach and provide an option to user 105, which may allow user 105 to conduct transactions using the compromised account number under limited conditions.

In some embodiments, financial service provider 130 may enable enhanced security verification measures for the compromised account number. For example, when financial service provider 130 detects that an account number of user 105 is compromised, it may suspend the account number. The financial service provider may disable the identifier (e.g., the PIN number) associated with the account number and determine (e.g., using a random number generation algorithm) a temporary identifier (e.g., a one-time PIN) for the compromised account number. For example, the financial service provider 130 may change the temporary identifier in a periodic (e.g., every 24 hours) or non-periodic manner (e.g., on demand of user 105). By doing so, the malicious third party may be blocked to access the funds of the compromised account (e.g., in a card-present transaction, such as a POS or ATM transaction) even if it has the previous identifier.

In some embodiments, financial service provider may also disable a security code associated with the account number. The security code may be associated with a financial processing service provider (e.g., VISA®, Mastercard®, Discover®, American Express®, JCB®, China UnionPay®, or the like). For example, the security code may be a card verification value (CVV), a card validation code (CVC), a card identification number (CID), card verification data (CVD), card authentication value (CAV), a card security code (CSC), a card validation number (CVN), or the like. After disabling the security code, the financial service provider may determine a new security code to be associated with the account number. For example, the financial service provider 130 may change the security code in a periodic (e.g., every few hours, days, or the like) or a non-periodic manner (e.g., each time when a transaction occurs). By doing so, the malicious third party may be blocked to access the funds of the compromised account (e.g., in a card-not-present transaction, such as a telephone or online transaction) even if it has the previous security code.

In some embodiments, after determining the temporary identifier and the new security code, financial service provider 130 may cause to send them (e.g., through Internet, telecommunication service, or mobile transaction cloud 170) to user device 110 associated with the compromised account number. For example, financial service provider 130 may display the temporary identifier and the new security code on an interface (e.g., an interface of a mobile banking application) of user device 110. Depending on the type of transactions, user 105 may choose to use the temporary identifier, the new security code, or both, to complete a financial transaction under the compromised account number. In some embodiments, user device 110 may be associated with user 105 before receiving the temporary identifier and the new security code. That is, user device 100 may be linked to user 105 to ensure that any communication to and from user device 110 is intended for user 105. For example, user device 110 may be associated with user 105 when user 105 logs in an email address associated with the account number on user device 110, inserts a SIM card of a phone number associated with the account number to user device 110, or logs in an application (e.g., a mobile banking application) provided by financial service provider 130 on user device 110, or the like.

In some embodiments, financial service provider 130 may set aside limited funds in the compromised account available to user 105 for immediate needs (e.g., food, gas, shelter, or the like). For example, financial service provider 130 may analyze transaction data (e.g., transaction history) and profile data of user 105, and determine a fund limit that allows user 105 to use for transactions. In some embodiments, financial service provider 130 may use an artificial intelligence technique (e.g., a machine learning technique such as a deep neural network) for the analysis of the transaction data and profile data. For example, the fund limit may be an average value of monthly expenditures of the account number in past time periods (e.g., past three months). In another example, the fund limit may be the aforementioned average value adjusted by an amount determined by the artificial intelligence technique. By doing so, user 105 may access funds of the compromised account number with convenience to satisfy necessary needs without risking depletion of all the funds in the account number. In some embodiments, such a measure may serve as a last resort to protect user 105's funds.

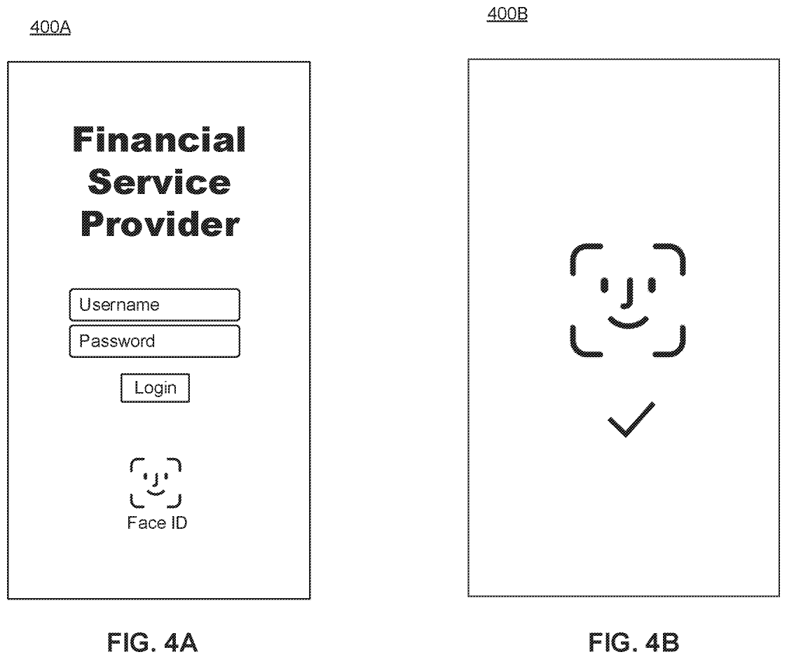

FIGS. 4A-4B depict example interfaces 400A and 400B presented on user device 110, consistent with the disclosed embodiments. For example, user device 110 may be a smartphone associated with user 105, and interfaces 400A or 400B may be displayed on user interface 340 (e.g., a display panel or a touchscreen). Interface 400A is a user login interface, in which user 105 may log in using a username and a password, using a face identification (e.g., by facial recognition), or via other means. Interface 400B is a login success interface that displays a successful login using face identification to user 105. For example, interfaces 400A and 400B may be interfaces of an application issued by financial service provider 130 and installed at user device 110. In another example, interfaces 400A and 400B may be interfaces of a website of financial service provider 130.

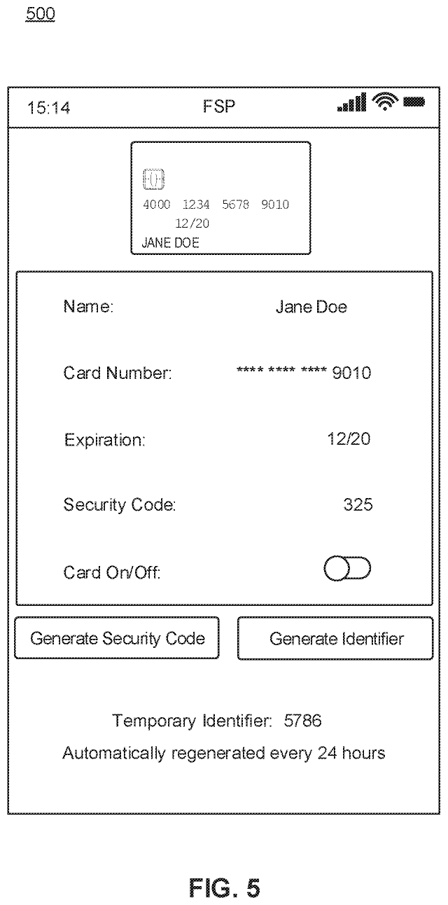

FIG. 5 depicts an example interface 500 shown on user device 110, consistent with the disclosed embodiments. In some embodiments, interface 500 may be an interface of an application issued by financial service provider 130 and installed at user device 110 or a website of financial service provider 130. For example, interface 500 may be displayed on user interface 340 of user device 110.

As shown in FIG. 5, user 105 may be an individual named “Jane Doe.” User 105 may have a financial account with financial service provider 130 that may be named as “Financial Service Provider” or “FSP.” An account number ending in 9010 may be associated with the financial account. For example, the account number may be provided by FSP in a physical form (e.g., a credit or debit card). The account number may be associated with an expiration date “12/20.” In FIG. 5, interface 500 displays in its top portion a representation of Jane Doe's account number ending in 9010 with the “12/20” expiration date. In the middle portion, interface 500 displays the name of user 105, the card number, the expiration date, the current security code (i.e., “325”), and a switch element named “Card On/Off” to enable or disable the card. When user 105 toggles with the switch element, the card ending in 9010 may be switched “on” where it can be allowed for transactions, or switched “off” where it can be declined for transactions.

In the bottom portion, interface 500 displays a button “Generate Security Code,” a button “Generate Identifier,” a temporary identifier “5786,” and texts (i.e., “Automatically regenerated every 24 hours”) indicating that the temporary identifier “5786” will be regenerated daily. When user 105 presses the button “Generate Security Code,” a request for generating a new security code different from “325” may be sent to a computer-implemented system (e.g., to server 200) of financial service provider 130, which may generate the new security code and send it back to user device 110 for display in the middle portion of interface 500 in place of “325.” When user 105 presses the button “Generate Identifier,” a request for generating a new temporary identifier different from “5786” may be sent to a computer-implemented system (e.g., to server 200) of financial service provider 130 (e.g., to server 200), which may generate the new temporary identifier and send it back to user device 110 for display in the bottom portion of interface 500 in place of “5786” even if “5786” was generated less than 24 hours ago. In some embodiments, when user 105 presses the button “Generate Identifier,” user device 110 may generate the new temporary identifier and display it in the bottom portion of interface 500 in place of “5786” even if “5786” was generated less than 24 hours ago, and then send the new temporary identifier to a computer-implemented system (e.g., to server 200) of financial service provider 130 to be synchronized to other components of financial service provider 130.

In some embodiments, when a data breach occurs, the account number ending in 9010 may be compromised, and FSP may freeze the account number. When user 105 uses the compromised account number (e.g., the card number ending in 9010) for a transaction (e.g., a payment), at least one of the temporary identifier or the new security code may be needed. Before further actions being taken (e.g., user 105 inputting the temporary identifier or the new security code), all transactions through the compromised account number ending in 9010 will be declined by either transaction processing network 120 or financial service provider 130.

To view the temporary identifier and the new security code, user 105 may log in to the application (e.g., through interfaces 400A and 400B) and view them in interface 500. In some embodiments, the security code (e.g., “325”) in interface 500 may be updated each time financial service provider 130 detects that a transaction involving the compromised account number occurs, no matter user 105 logs in the application to view interface 500 or not. In some embodiments, the temporary identifier (e.g., “5786”) in interface 500 may be updated every 24 hours, no matter user 105 logs in the application to view interface 500 or not.

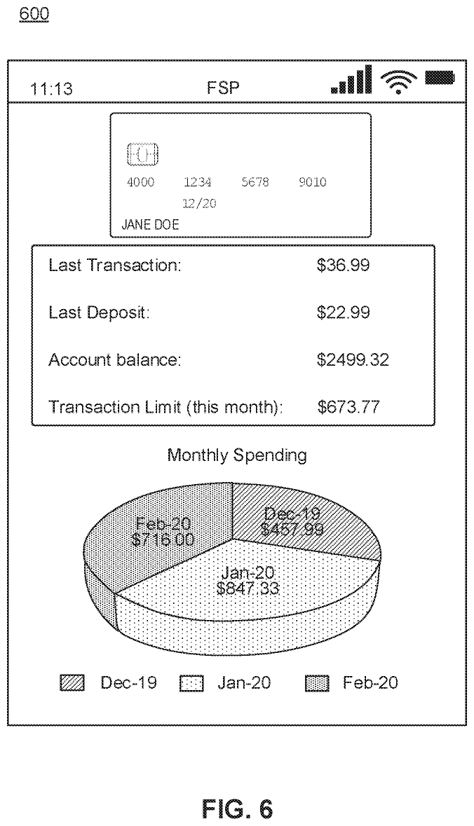

FIG. 6 depicts an example interface 600 shown on user device 110, consistent with the disclosed embodiments. In some embodiments, interface 600 may be an interface of an application issued by financial service provider 130 and installed at user device 110 or a website of financial service provider 130. For example, interface 600 may be displayed on user interface 340 of user device 110.

As shown in FIG. 6, interface 600 displays in its top portion a representation of Jane Doe's account number ending in 9010 with the “12/20” expiration date. In the middle portion, interface 600 displays a summary of the account, including an amount of the last transaction, an amount of the last deposit, a current account balance, and a transaction limit for the current month. User 105 may use the compromised account number to conduct transactions in the current month if the accumulated transaction amount is within the transaction limit (e.g., $673.77). In the bottom portion, interface 600 displays a pie chart of monthly spending of the account number ending in 9010 in December 2019, January 2020, and February 2020.

In some embodiments, when the account number ending in 9010 is compromised, financial service provider 130 may set the transaction limit for user 105 to protect the funds. For example, as shown in FIG. 6, the total funds in the account number is $2499.32, but the funds available for user 105 to use in the current month is $673.77. By doing so, user 105 may access to funds of the compromised account number with convenience to satisfy necessary needs without risking depletion of all the funds in the account number.

In some embodiments, financial service provider 130 may analyze transaction data (e.g., transaction history) and profile data of user 105, and determine the transaction limit (e.g., $673.77). For example, in FIG. 6, financial service provider 130 may determine an average monthly spending for December 2019, January 2020, and February 2020 as $673.77, and set this value as the transaction limit for the current month. By doing so, financial service provider 130 may determine the transaction limit in considerations of a recent spending pattern of user 105, and thus balance the security of the funds in the compromised account number and the probable needs of user 105.

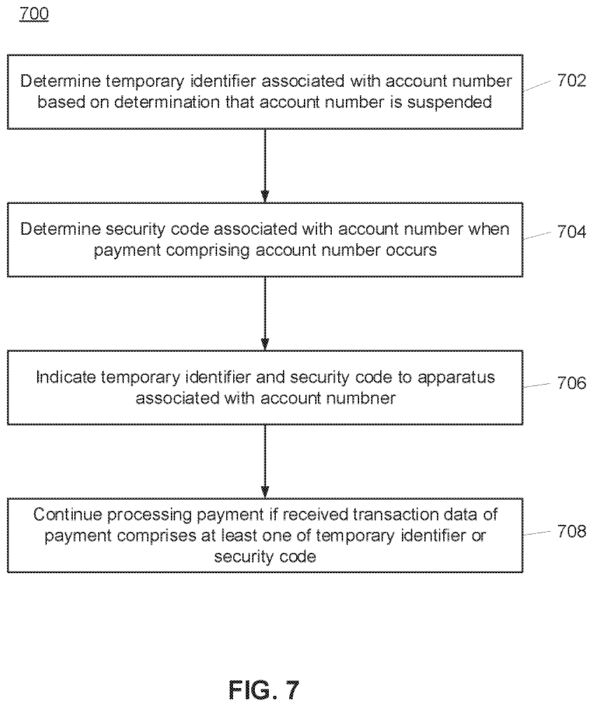

FIG. 7 is a flowchart of example process 700 for processing a financial transaction in system 100, consistent with the disclosed embodiments. Process 700 may be performed by a computer-implemented system (e.g., server 200) in transaction processing network 120 or financial service provider 130, or by an apparatus (e.g., user device 110). The computer-implemented system may include a memory (e.g., memory 230 or 330) that stores instructions and a processor (e.g., processor 210 or 310) programmed to execute the instructions to implement process 700. Process 700 may be connected to the operations shown and described above with respect to FIGS. 4A-6. For example, process 700 may be implemented as one or more software modules (e.g., an API in transaction analyzer 212) stored in memory 230 and executable by processor 210.

Referring to FIG. 7, at step 702, the processor may determine a temporary identifier (e.g., a temporary PIN number) associated with an account number (e.g., a card account number) based on a determination that the account number is suspended. For example, the account number may be associated with (e.g., owned by) user 105. In some embodiments, the account number may be suspended due to data compromise or possible fraudulent activity identified by financial service provider 130.

In some embodiments, the processor may determine the temporary identifier using a random number generation technique. For example, the processor may generate the temporary identifier without knowing the identifier previously associated with the account number (e.g., an old PIN number). In some embodiments, the processor may determine the temporary identifier in a periodic manner, in which the period may be in hours, days, weeks, or any length of time. For example, as shown in FIG. 6, the processor may determine the temporary identifier in every 24 hours. In some embodiments, the period may be set by user 105. In some embodiments, the processor may determine the temporary identifier in a non-periodic manner. For example, the processor may determine the temporary identifier in random time intervals. In another example, the processor may determine the temporary identifier when user 105 indicates so (e.g., by pressing the button “Generate Identifier” in interface 500 of FIG. 5). In some embodiments, the processor may determine the temporary identifier in both the periodic manner and the non-periodic manner. For example, without intervention of user 105, the processor may determine the temporary identifier in the periodic manner, and when user 105 intervenes, the processor may determine the temporary identifier on-demand.

Still referring to FIG. 7, at step 704, the processor may determine a security code (e.g., a CVV code) associated with the account number when a payment comprising the account number occurs. For example, the payment may be a card-present transaction (e.g., a POS transaction or an ATM transaction). In another example, the payment may be a card-not-present transaction (e.g., a telephone transaction or an online transaction). In some embodiments, the processor may determine the security code every time a payment comprising the account number occurs. In some embodiments, the processor may determine the security code if user 105 instructs so (e.g., by pressing the button “Generate Security Code” in interface 500 of FIG. 5). In some embodiments, the processor may determine the security code in a periodic manner (e.g., in hours, days, weeks, or any length of time). In some embodiments, the processor may determine the security code in both a non-periodic manner and a periodic manner. For example, without intervention of user 105 or any occurrence of payments comprising the account number, the processor may determine the security code in the periodic manner. When user 105 intervenes or a payment comprising the account number occurs, the processor may determine the security code on-demand.

In some embodiments, the processor may determine the security code using a transaction processing service provider (e.g., VISA®, Mastercard®, Discover®, American Express®, JCB®, China UnionPay®, or the like). For example, the processor may send the account number (e.g., the card number ending in 9010 shown in interface 500 of FIG. 5) and an expiration date (e.g., the expiration date “12/20” shown in interface 500 of FIG. 5) associated with the account number to the transaction processing service provider. In some embodiments, the processor may send the account number and the expiration date to an API (e.g., a dCVV2 API provided by VISA®) provided by the transaction processing service provider through a network (e.g., Internet or mobile transaction cloud 170). The transaction processing service provider may validate the account number and the expiration date, and generate authentication data if the validation is successful. The transaction processing service provider may send the authentication data to the processor (e.g., via mobile transaction cloud 170). After receiving the authentication data from the transaction processing service provider, the processor may determine the security code using the authentication data.

In some embodiments, the processor may determine the security code without using any transaction processing service provider. For example, the processor may validate the account number and the expiration date, and generate the security code if the validation is successful. In some embodiments, the processor may further check whether the generated security code has been used, and if so, may generate a new one.

Still referring to FIG. 7, at step 706, the processor may indicate the temporary identifier and the security code to an apparatus (e.g., user device 110) associated with the financial account. In some embodiments, if the processor determines the temporary identifier and the security code, the processor may transmit the temporary identifier and the security code to the apparatus for display (e.g., on user interface 340). For example, the processor may indicate the temporary identifier and the security code on interface 500 in FIG. 5. In some embodiments, the processor may indicate (e.g., via transmission) the temporary identifier and the security code to the apparatus via one of a text message, a push notification, an in-app notification (e.g., interface 500), an email, or a telephone call.

In some embodiments, if the temporary identifier is generated by a processor (e.g., processor 310) of user device 110 (as described at step 702), processor 310 may cause user device 110 to display the temporary identifier. For example, before displaying the temporary identifier, user device 110 may generate the temporary identifier and transmit it to server 200, which may in turn determine (e.g., by processor 210) whether the generated temporary identifier has been used before by user device 110 or be associated with another account. If so, server 200 may communicate with user device 220 (e.g., via communication interface 350) to cause user device 110 to re-generate the temporary identifier.

In another example, before displaying the temporary identifier, user device 110 may generate the temporary identifier using a shared-secret based algorithm. The shared-secret based algorithm may be independently performed by user device 110 and server 200 to generate identical temporary identifiers. The shared-secret based algorithm may include, for example, an HMAC-based one-time password (HOTP) algorithm that is based on hash-based message authentication codes (HMAC), a time-based one-time password (TOTP) algorithm, or the like. In the shared-secret based algorithm, a “shared secret” (e.g., a sequence of bytes not exposed to third parties) may be synchronized between devices running the same shared-secret based algorithm for setting up. For example, the processor (e.g., processor 210) of server 200 may convert the shared secret to a QR code to be displayed on a screen seen by user 105, and user 105 may use user device 110 to scan the QR code (e.g., using an authentication application installed in user device 110) to synchronize the shared secret between user device 110 and server 200. After the synchronization, both server 200 and user device 110 may independently generate the same temporary identifier using the same shared-secret. By doing so, user 105 may examine the temporary identifier at any time (e.g., by opening the authentication application) without waiting for communication from server 200.

Still referring to FIG. 7, at step 708, the processor may continue processing the payment if received transaction data of the payment comprises at least one of the temporary identifier or the security code. For example, if the payment is a card-present transaction, the processor may reject the payment if the received transaction data of the payment does not include the temporary identifier. Otherwise, the processor may approve the payment. In another example, if the payment is a card-not-present transaction, the processor may reject the payment if the received transaction data of the payment does not include the security code. Otherwise, the processor may approve the payment. In yet another example, if the payment needs both the temporary identifier and the security code to proceed, the processor may reject the payment if the received transaction data of the payment includes neither the temporary identifier nor the security code. Otherwise, the processor may approve the payment.

In some embodiments, the processor may implement more operations before approving the payment. For example, the processor may determine a fund limit of the suspended account number, in which the fund limit is available for payments in a time period (e.g., in a day, a week, a month, or any length of time period). In some embodiments, the fund limit may be an average value of monthly expenditures of the account number in a past time range (e.g., in past days, weeks, months, or any length of time range). For example, as shown in FIG. 6, the fund limit may be available for payments in a month, and it may be an average value of monthly expenditures of the account number in the past three months.

In some embodiments, the processor may determine the fund limit using an artificial intelligence (AI) technique (e.g., a machine learning technique). For example, the AI technique may use a deep neural network (DNN) model, a behavioral AI technique (e.g., a machine learning technique that models behavior and cognition of the human brains), or the like. In some embodiments, the AI technique may use at least one of a balance of the account number (e.g., the $2499.32 in interface 600 of FIG. 6), transaction data of the account number in a past time range, a credit score (e.g., a credit score of user 105) associated with the account number, or user profile data (e.g., user profile data of user 105) associated with the account number as input. In some embodiments, if the account number is a credit card number, the AI technique may further use at least one of an annual percentage rate associated with the account number, a credit line, or a prepaid balance as input.

For example, the transaction data may include at least one of a past individual expenditure (e.g., including the “last deposit” in interface 600), a past individual deposit (e.g., including the “last deposit” in interface 600), an overall past expenditure (e.g., including the monthly spending in interface 600), an overall past deposit, a type (e.g., purchase, bill payment, inter-person transfer, or the like) of the transaction, a location of the transaction, an time of the transaction, or the like. In another example, the user profile data may include an annual income of user 105, an occupation of user 105, a current debt liability of user 105, a line of credit of user 105, a relationship between user 105 and financial service provider 130, or the like.

In some embodiments, based on the relationship between user 105 and financial service provider 130, the processor may determine the fund limit only when such a relationship satisfies one or more predetermined conditions (e.g., the length of the relationship, whether user 105 was past due on any debt liability to financial service provider 130, a total asset of user 105 in financial service provider 130, or the like).

In some embodiments, the fund limit may be a transaction-wise limit, in which single transactions exceeding the fund limit may be declined or halted. In another example, the fund limit may be an accumulation-type limit (e.g., a daily, weekly, or monthly limit), in which an accumulated transaction amount is monitored, and transactions that render the accumulated transaction amount to exceed the fund limit may be declined or halted.

In some embodiments, after step 708, the processor may approve the payment if the payment is within the fund limit. Otherwise, the processor may reject the payment if the payment is not within the fund limit.

In some embodiments, after step 708, if the payment is within the fund limit but the balance of the account is insufficient to complete the transaction, the processor may provide provisional funds to the account to approve the payment. For example, user 105's account may be suspended due to fraudulent activities (e.g., data breach), and some of the balance of the account may have already been spent by a malicious third party before the account suspension. In those cases, user 105 may be in a process of transaction that is within the fund limit, but would still be frustrated because of the remaining balance of the account may be insufficient. To mitigate customer frustration, the processor may temporarily approve the transaction by providing provisional funds to the account. In some embodiments, the total provisional funds provided to the account may not exceed the fund limit determined by the processor. In some embodiments, the provisional funds may be reimbursed by clawing back the fraudulent transaction conducted by the malicious third party, or by insurance compensation.

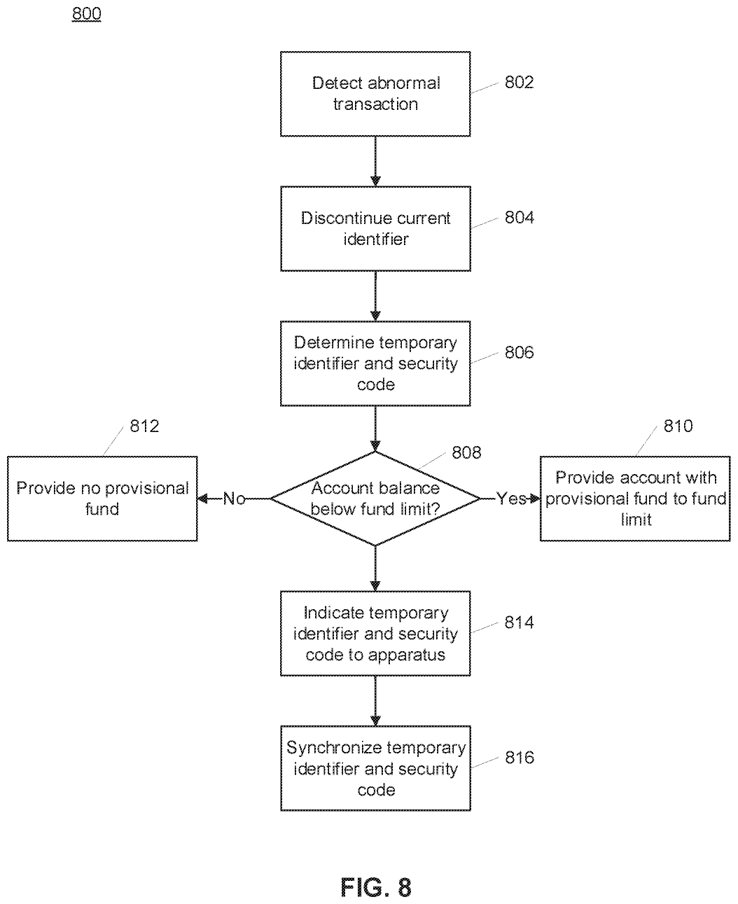

FIG. 8 is a flowchart of example process 800 for processing a financial transaction in system 100, consistent with the disclosed embodiments. Process 800 may be performed by a computer-implemented system (e.g., server 200) in transaction processing network 120 or financial service provider 130. The computer-implemented system may include a memory (e.g., memory 230) that stores instructions and a processor (e.g., processor 210) programmed to execute the instructions to implement process 800. Process 800 may be connected to the operations shown and described above with respect to FIGS. 4A-6. For example, process 800 may be implemented as one or more software modules (e.g., an API in transaction analyzer 212) stored in memory 230 and executable by processor 210.

Referring to FIG. 8, at step 802, the processor may detect an abnormal transaction for an account number. For example, the account number may have been suspended but is involved in a transaction. In another example, the account number may not be suspended but the transaction amount and location are out of the transaction pattern of the account number, such as the transaction occurs in a location in another country with a large amount.

At step 804, the processor may discontinue a current identifier (e.g., a PIN) associated with the account number for security of the account number. At step 806, the processor may determine a temporary identifier and a security code. For example, the processor may perform step 806 in the operations as described in steps 702-704 of process 700 in FIG. 7, and will not be repeated hereinafter.

At step 808, the processor may determine whether an account balance of the account number is below a fund limit. The fund limit may be the fund limit as described in step 708 of process 700 in FIG. 7, and will not be repeated hereinafter. For example, the processor may determine the fund limit using an AI technique.

If the account balance is below the fund limit, at step 810, the processor may provide the account number with a provisional fund up to the fund limit. If the account balance is not below the fund limit, at step 812, the processor may not provide the account number with the provisional fund. Steps 810-812 may be implemented as described above with respect to step 708. By operations of 810-812, the account number may be ensured to have sufficient funds to complete the abnormal transaction in case the abnormal transaction may be validated (as described in the following operations).

At step 814, the processor may indicate the temporary identifier and the security code to an apparatus associated with the account number. For example, the processor may perform step 814 in the operations as described in step 706 of process 700 in FIG. 7, and will not be repeated hereinafter.

At step 816, the processor may synchronize the temporary identifier and security code to other computer-implemented systems in financial service provider 130 or transaction processing network 120. For example, the temporary identifier may be determined by a processor (e.g., processor 210) of a computer-implemented system (e.g., server 200). After generating the temporary identifier, processor 210 may synchronize the temporary identifier to other components of system 100 (e.g., a hardware security module or HSM in financial service provider 130 or transaction processing network 120). By performing step 816, the financial service provider 130 and transaction processing network 120 may obtain the updated temporary identifier and security code for processing the transaction.

A non-transitory computer-readable medium may be provided that stores instructions for a processor (e.g., processor 210 or 310) for processing a financial transaction according to the example flowcharts of FIGS. 7-8 above, consistent with embodiments in the present disclosure. For example, the instructions stored in the non-transitory computer-readable medium may be executed by the processor for performing process 700 or 800 in part or in entirety. Common forms of non-transitory media include, for example, a floppy disk, a flexible disk, hard disk, solid-state drive, magnetic tape, or any other magnetic data storage medium, a Compact Disc Read-Only Memory (CD-ROM), any other optical data storage medium, any physical medium with patterns of holes, a Random Access Memory (RAM), a Programmable Read-Only Memory (PROM), and Erasable Programmable Read-Only Memory (EPROM), a FLASH-EPROM or any other flash memory, Non-Volatile Random Access Memory (NVRAM), a cache, a register, any other memory chip or cartridge, and networked versions of the same.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system comprising:
a non-transitory computer-readable medium configured to store instructions; and
at least one processor configured to execute the instructions to perform operations comprising:
determining a temporary identifier associated with an account number based on a determination that the account number is suspended;
determining a security code associated with the account number when a payment comprising the account number occurs;
indicating the temporary identifier and the security code to an apparatus associated with the account number; and
continuing processing the payment if received transaction data of the payment comprises at least one of the temporary identifier or the security code.

2. The computer-implemented system of claim 1, wherein the operations further comprise:
based on the determination that the account number is suspended, determining a fund limit of the account number available for payments in a time period.

3. The computer-implemented system of claim 2, wherein determining the fund limit is based on an average value of monthly expenditures of the account number in a past time range.

4. The computer-implemented system of claim 2, wherein the operations further comprise:
determining the fund limit using an artificial intelligence technique, wherein the artificial intelligence technique uses at least one of a balance of the account number, transaction data of the account number in a past time range, a credit score associated with the account number, or user profile data associated with the account number as input.

5. The computer-implemented system of claim 2, wherein the operations further comprise:
approving the payment if the payment is within the fund limit; or
rejecting the payment if the payment is not within the fund limit.

6. The computer-implemented system of claim 1, wherein the operations further comprise:
rejecting the payment if the received transaction data of the payment does not include the temporary identifier, wherein the payment is a card-present transaction.

7. The computer-implemented system of claim 1, wherein the operations further comprise:
rejecting the payment if the received transaction data of the payment does not include the security code, wherein the payment is a card-not-present transaction.

8. The computer-implemented system of claim 1, wherein determining the temporary identifier comprises:
determining the temporary identifier in a periodic manner.

9. The computer-implemented system of claim 1, wherein determining the security code comprises:
sending the account number and an expiration date associated with the account number to a transaction processing service provider;
receiving authentication data from the transaction processing service provider; and
determining the security code using the authentication data.

10. The computer-implemented system of claim 1, wherein indicating the temporary identifier and the security code to the apparatus comprises:
indicating the temporary identifier and the security code to the apparatus via a text message, a push notification, an in-app notification, an email, or a telephone call.

11. A computer-implemented method comprising:
determining a temporary identifier associated with an account number based on a determination that the account number is suspended;
determining a security code associated with the account number when a payment comprising the account number occurs;
indicating the temporary identifier and the security code to an apparatus associated with the account number; and
continuing processing the payment if received transaction data of the payment comprises at least one of the temporary identifier or the security code.

12. The computer-implemented method of claim 11, further comprising:
based on the determination that the account number is suspended, determining a fund limit of the account number available for payments in a time period.

13. The computer-implemented method of claim 12, wherein determining the fund limit is based on an average value of monthly expenditures of the account number in a past time range.

14. The computer-implemented method of claim 12, further comprising:
determining the fund limit using an artificial intelligence technique, wherein the artificial intelligence technique uses at least one of a balance of the account number, transaction data of the account number in a past time range, a credit score associated with the account number, or user profile data associated with the account number as input.

15. The computer-implemented method of claim 12, further comprising:
approving the payment if the payment is within the fund limit; or
rejecting the payment if the payment is not within the fund limit.

16. The computer-implemented method of claim 11, further comprising:
rejecting the payment if the received transaction data of the payment does not include the temporary identifier, wherein the payment is a card-present transaction.

17. The computer-implemented method of claim 11, further comprising:
rejecting the payment if the received transaction data of the payment does not include the security code, wherein the payment is a card-not-present transaction.

18. The computer-implemented method of claim 11, wherein determining the temporary identifier comprises:
determining the temporary identifier in a periodic manner.

19. The computer-implemented method of claim 11, wherein determining the security code comprises:
sending the account number and an expiration date associated with the account number to a transaction processing service provider;
receiving authentication data from the transaction processing service provider; and
determining the security code using the authentication data.

20. The computer-implemented method of claim 11, wherein indicating the temporary identifier and the security code to the apparatus comprises:
indicating the temporary identifier and the security code to the apparatus via a text message, a push notification, an in-app notification, an email, or a telephone call.
